(19) United States
(12) Patent Application Publication
(10) Pub. No.: US 2003/0036928 A1
(43) Pub. Date: Feb. 20, 2003

(54) Must fly

(76) Inventors: Galit Kenigsberg, Holon (IL); Daniel Aharon, Holon (IL); Itai Kohavi, Hod Hasharon (IL)

Correspondence Address: KATTEN MUCHIN ZAVIS ROSENMAN, 575 MADISON AVENUE, NEW YORK, NY, 10022-2585, US

(21) Appl. No.: 09/805,391

(22) Filed: Mar. 13, 2001

(51) Int. Cl. G06F 17/60

(52) U.S. Cl. 705/5; 705/14

(57) ABSTRACT

A system and method that maximizes the revenues of an airline for a selected flight by automatically balancing the consumption of flight tickets between travelers who have different demand curves for the same flight, which is sold out at a given time. The system accepts information from customers who have a high demand for a specific flight, while there are no available tickets that fit their needs (Type A customers), and finds customers that own tickets to the flight, but have lower demand for being on that flight (Type B customers). Based on advanced rules the system offers substitutes to Type B customers for giving away their tickets, and sells it to Type A customers who pay a different price for the tickets than Type B customers.

### BACKGROUND OF THE INVENTION

1. Field of Invention

The present invention relates generally to the field of travel bookings. More specifically, the present invention is related to a system and method for exchanging existing lower demand, lower priced bookings for high demand, high priced ticket requests on fully booked flights.

The following definitions may assist in an understanding of terminology used throughout the specification. The definitions are of a general nature and known definitions may be substituted where appropriate:

1. “Type A/requesting customers”—customers who have high demand for a specific flight, who are therefore willing to pay a significantly higher price for a seat on a specific flight.

2. “Type B/delay customers”—customers that own a ticket to a specific flight, but are expected to have lower demand to the flight than Type A customers. There are three main types of type B customers:

Tickets holders who wish to cancel/postpone a flight for whatever reason

Tickets holders who own delayable tickets

Tickets holders who are offered an incentive to give away their seat on a flight. The incentives may be financial, a flight upgrade, points accumulation, a cheaper ticket, bonus tickets, more lenient payment terms, etc.

3. “delayable ticket”—a ticket which is sold at a cheaper price with the understanding that the airline can reschedule the passenger's flight up to a few hours before the flight is due to leave. The passenger is placed on another mutually accepted flight, or if no such flight is found, the airline reimburses the passenger. The “delayable ticket” contract states the number of times the airline can postpone a passenger's flight. Cancellation is in the majority of cases one-sided—a passenger with this type of ticket wishing to cancel would be subject to high cancellation fees. It is possible to buy up a few joint delayable tickets; modification of one such ticket would mean the automatic modification of the others.

4. “Type C customers”—customers that the system actively approaches, offers them a flight ticket, and makes a decision of which terms to sell them the ticket.

5. “Dynamic fare”—tickets that were booked via the Internet or other means while the airlines allowed the customers to control the ticket price and ticket type by choosing various options. These options are offered to the customer in coordination with the airline's booking system so that what options are offered are assessed by the airline each time. Among various options, you can find the following: giving away the ticket if approached by the airline, willing to give away the ticket if notified up to X hours before the flight, willing to be approached to give away ticket for specific incentives, getting the option to cancel/postpone the flight, and number of joint tickets.

2. Discussion of Prior Art

A majority of the airline companies frequently face the problem of overbooking on their flights, which is traditionally dealt with at the airport. Presently airlines intentionally overbook flights based on historical data of various routes, schedules, timing (e.g., holidays, summer, Mondays, Sundays, etc.) and fare classes (first class, business class, economy, etc.). It is expected, based on the data, that a certain number of passengers will either cancel or not make their flights (e.g., late). According to the U.S. Department of Transportation, some million plus passengers are bumped from flights each year. There is a need, however, to balance the airlines wish to fill each and every flight with the fear of leaving a ticket-holding passenger off the plane. In addition, the ability of the airlines to control overbooking at the terminal is restricted to last minute decisions by both the airlines and the passengers.

When overbooking occurs, the airlines offer a form of compensation to the displaced ticket holder. Typically, a free ticket on the same airline, upgrades, vouchers or some cash equivalent is offered to those passengers willing to give up their tickets. The airlines make most of their profit from a relatively small share of the passenger market, businesspeople, for example, buy only 20% of the tickets but they make up 50% of the profits. Such companies are trying to maximize profits in a number of different ways. By, for example, splitting the economy class into two sub-classes, or by splitting the business class into a number of sub-classes in an attempt to sell more expensive tickets to more passengers. What is needed is a means to give the airline companies sole control over ticket prices and a system and method to maximize these profits in the overbooked flight environment, meeting one or more of the following objectives:

Maximizing the airlines profits by preferential treatment of that part of the passenger market that yields the highest profits for the airline, while maintaining control over ticket prices.

Regulating overbooking using the Internet, preferably prior to arrival at the airport.

Making it possible for a customer, who has to be on a specific flight, for whatever reason, which has no available seats, to book on the Internet a ticket which is in someone else's name at the time of booking. These and other benefits are achieved by the detailed description that follows.

### SUMMARY OF THE INVENTION

A software system and method that maximizes the revenues of a travel product provider, e.g. a flight for an airline, by automatically balancing the consumption of flight tickets between travelers who have different demand curves for the same flight, which is sold out at a given time. The software accepts information from customers who have high demand for a specific flight, while there are no available tickets that fit their needs (Type A customers), and finds customers that own tickets to the flight, but have lower demand for being on that flight (Type B customers). Based on advanced rules, the software offers substitutes to Type B customers for giving away their tickets, and sells them to Type A customers who pay a different price for the tickets than Type B customers. The decision making process is based on rules defined by the airlines, predefined rules within the system, and on updated data which is received in real time from the airline and from the Internet.

The connection within the software to Type A & Type B customers is done automatically via the Internet (typically through a website) and by phone, both landline and mobile. The product is any seat on a certain flight, at a specific time, to a specific destination, or a seat in a specific class, or a specific seat (such as a window seat).

### BRIEF DESCRIPTION OF THE DRAWINGS

FIG. 1 illustrates the system of the present invention.

FIGS. 2a and 2b, collectively illustrate a flowchart of the seat request processing method of the present invention.

FIG. 3 illustrates a flowchart of the seat searching method of the present invention.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. The preferred embodiment is directed to an airline maximizing revenue on sold out flights, however other transportation modes and products are considered within the scope of the invention.

The present invention enables an airline to offer a service to deal with overbooking using the Internet or other communication mediums prior to arrival at the airport. The company will be able to maximize profits by offering a seat to any businessperson and/or passenger agreeing to pay a higher price, and preferring them over those buying cheaper tickets. In certain circumstances, this same company will be able to initiate the offering of tickets to customers.

### The Basic Assumptions of the Software

1. There is a market share of customers for whom being on a specific flight at a specific time is important and who are willing to pay a significantly higher price for the service these will be called “requesting” customers.

2. The market share of “requesting” customers maximizes the profits of the travel service suppliers, and so is preferred over those buying these services at an earlier date for a cheaper price.

3. That overbooking occurs at times for certain classes (first, business, etc).

4. That there is a market share of passengers, who in certain circumstances for the right incentive would be willing to give up their ticket—these will be called “giving away” passengers.

### “Requesting” Customers

Those who order tickets using the present invention are likely to be businesspeople, well-off customers, regular customers who have to be at a specific destination at a specific time and travel agents who have committed to providing a client with a place on a specific flight. These customers will want to make use of the present invention when they need to make a particular flight, which has no available tickets (business meetings, sports events, etc.) or would just prefer a concentrated search which saves time and guarantees a ticket at the best price available (including the possibility of an additional cost).

### “Giving Away” Passengers

Passengers who wish to cancel/postpone a flight for whatever reason, delayable ticket holders, and/or ticket holders who are offered an incentive to give up their place on a flight. The incentives might be financial, a flight upgrade, points accumulation, a cheaper ticket, package and/or an incentive not directly connected to the flight such as a payment scheme.

### Assimilation of the Present Invention Software by the Airline Company

There are three main options for assimilation of the software within the airlines' web sites. Each of the options allows for electronic communications including, in a preferred embodiment, mobile phone connectivity.

1. Separate software for each airline company.

2. A central Internet site (B2C) for all the airlines (ASP—Application Service Provider).

3. A preferred embodiment central Internet site (B2B), which will include web pages for each airline (ASP).

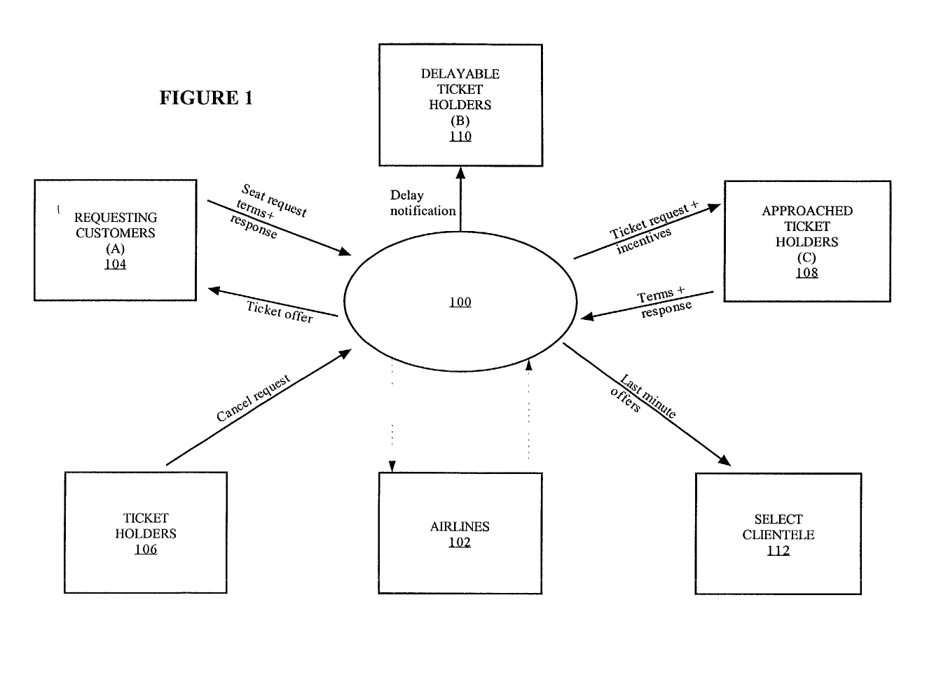

FIG. 1 illustrates the major system entities and data flow of the present invention. The present invention software 100, includes but is not limited to, rules based processing of customer, airline and real time data in conjunction with communications schemas, customer, airline and financial interfaces.

### The Software

The software receives requests 104 (requesting customers) from customers willing to pay a higher than the quoted price for a ticket, and decides whether to sell them a flight ticket and at what terms.

This same system identifies ticket holders 110 on the specified flight and decides, within a reasonable period of time (in acquiescence with the passenger or not depending on the ticket type) whether or not to delay their flight, whether or not to compensate them, and in what manner.

In addition, the system receives cancellation requests from passengers 106 with tickets for a particular flight and decides within a reasonable period of time whether or not to cancel the ticket and at what terms.

In conjunction, when flights have empty seats, the system can actively approach 108, in certain circumstances, customers and offer them a ticket and decide at what terms to sell them the ticket; may include select clientele 112.

The decision making process is based on rules defined by the individual airlines and upon data which is received in real time from airlines' internal systems (e.g., revenue management system, reservation system).

The main decisions are at what price to offer the ticket to the customer (“requesting” customers), the time frame within which an answer will be given to the customer, which customers to approach to cancel their ticket (“giving away” passengers 106, 110), in what order to approach them, and what incentives should be offered. In what circumstances and to which customers should tickets, which have become available on the flight, be actively offered, and whether to cancel tickets of passengers wanting to cancel and at what terms.

The rules are set up by the airline before the software is activated, according to their systems' data. The data is received in real time from the yield management systems, from the airline's inventory systems and from the airline's Internet site 102 or that of a third party (e.g., distributors). The data includes information on the number of available seats on the flight, passenger personalization data, the number of “requesting” customers and “canceling” passengers at any one time, statistical data, and more as detailed further on.

### “Requesting” Customer—Ordering a Ticket When There are no Available Seats on a Flight

1. A customer wishing to order a ticket for a specific flight, which has no available seats, contacts the system (by phone, mobile, e-mail or the Internet), orders a ticket according to the criteria of location, time, class, and feeds in their credit card details. The order details are displayed immediately, along with the ticket price and the latest time by which the ticket will be confirmed. Once the order is confirmed, the customer commits to buying a ticket if one is found within the agreed time. Payment is collected when an available seat is found.

2. Ticket price is calculated for the “requesting’ customer by a customer sensitive yield management system. That is, it is calculated for a specific customer, for a specific flight and is dependent on when the order was placed. The criteria for price calculation are fed in by the airline before the software is activated taking into account the following considerations:

List price of the flight

How long before the flight the order was placed (urgency of the order)

Number of “requesting” customers in the system at the time the order was placed

How many passengers holding “delayable tickets” are booked on the flight

How many passengers with the potential to give up their seat are booked on the flight (based on past behavior)

Number of available seats on corresponding flights of same/other airlines

Personal data available in the system on “requesting” customers

Sales promotion considerations

Anticipated cost to the airline to change the ticket of “Giving away” passengers

Profit margin that the airline wishes to attain using the service

Past price statistics

3. The latest time by which a requested ticket will be confirmed is fed in by the airline according to the following parameters:

How long before the flight the ticket was requested (urgency of the order)

How many passengers with “delayable tickets” are booked on the flight

How many passengers with the potential to give away their seat are booked on the flight

Personalization of the “requesting” customer and the other requesting customers in the system

Statistical data on the ticket confirmation times

4. The software checks whether there are no available seats on the flight (last minute cancellations), if there are available seats a ticket is booked for the “requesting” customer at the price that was displayed by the software.

5. If there are no available seats the system scans the passenger list and produces the following information about “giving away” customers:

Passengers wishing to cancel their flight.

Passengers holding “delayable tickets”.

Passengers potentially willing to give up their ticket.

6. The software decides on the order in which “giving away” passengers should be approached according to the rules set up by the airline at the time the software was installed. (Detailed further on).

7. The software decides on the compensation to be offered to each passenger, following instructions written by the airline, via rules.

8. After the “giving away” passenger confirms and/or receives notification of their flight cancellation, the software sends an official electronic confirmation detailing the flight cancellation and the compensation to be received. In conjunction, the airline deals with settlement of the compensation by sending a secured notification to the relevant company department (sales, finance, etc.).

9. The “requesting” customer receives notification within the agreed time. When there is no ticket (a negative answer), alternative flights, which do have seats that can be acquired for the customer, are displayed. If the answer is positive there is the usual booking process, the customer's account is debited and their name added to the passenger list.

10. It is possible in the following instances to combine negotiation functions:

Negotiation between the airline and the “requesting” customer, on the terms of the ticket and its price.

Negotiation between the airline and the “requesting” customer in cases where there is more than one “requesting” customer interested in the last ticket (a sort of public auction).

??? should we put references here to our negotiation patent ???

### Approaching “Giving Away” Passengers

When a request is received from a “requesting” customer the software scans the passenger list and identifies the relevant passengers and approaches them in the order laid down by the airline upon installation of the software.

### Customers with “Delayable Tickets”

1. Every flight has a limited number of passengers with “delayable tickets” based on the airline's considerations. “Delayable tickets” are sold to customers at a cheaper price with the understanding that the airline can postpone the passenger's flight up to a few hours before the flight is due to leave. The passenger is placed on another mutually accepted flight, or if no such flight is found, the airline reimburses the passenger. The “delayable tickets” contract states the number of times the airline can postpone a passenger's flight. Cancellation is solely one-sided—a passenger with this type of ticket wishing to cancel would be subject to high cancellation fees. It is possible to buy up to X joint fare cancellation tickets, cancellation of one such ticket would mean the automatic cancellation of the other.

2. The system receives a request from one “requesting” customer—scans the passenger list and identifies passengers with “delayable tickets”.

3. The system decides in what order to approach passengers with “delayable tickets” according to the rules defined by the airline at the time the software was installed and according to the following criteria:

Price of the ticket

Is it a single or a joint fare

Type of passenger (personalization)—age, membership of the airline's customer club, etc.

Number of forced delays the passenger has had so far with this ticket

How long before flight departure the ticket was booked

Has a seat been booked/check in processed/suitcases were loaded?

4. The system approaches these passengers automatically (by phone, mobile, e-mail or the Internet), and informs them of the flight cancellation and of possible new flight times. If notification is by phone—these passengers can press a special phone button on the phone during notification and arrange a new flight time. In any case, there is a phone number to ring or they can connect via the Internet—and in both cases reach the automatic booking and arrange a new flight time.

5. The system is capable of automatically coordinating newly available flight seats via electronic communication with the booking center.

### Customers Wishing to Postpone/Cancel their Flight

1. Passengers with tickets, who wish to cancel their flight and pay the lowest possible cancellation fees, approach the system either by phone or the Internet and ask to either cancel or postpone their flight. From the moment such a request is received by the system, in most cases, the passenger is committed to canceling/postponing their flight and cannot change their mind. The software can either accept/or reject the request within a given period of time that is defined by the software.

2. The time frame by which the passenger's request to cancel/postpone their flight has to be confirmed and the cancellation fee due is defined according to rules set up by the airline and are based on one or more of the following criteria:

List price of the flight

Flight ticket fare

Time left before the flight

Personalization of the passenger wishing to give up their ticket

Number of “requesting” customers in the system

Personalization of the “requesting” customers

Whether or not the flight is fully booked

Past statistics

Number of passengers with fare cancellations booked on the flight

Number of passengers wishing to give up their seat at the same time

How long before the flight departure the ticket was booked

3. The system crosschecks data opposite the “requesting” customers, calculates the cancellation fee as specified in section 2 and confirms the cancellation by sending the passenger an official electronic notification detailing the agreement (flight cancellation, new flight time, and/or the cancellation fee due). In conjunction, the software deals with reimbursing the ticket cost minus the deductions and/or coordinating a new flight time by sending a secured notification to the relevant department (sales, finance, etc.), and with the relevant handling of the “requesting” customers.

4. It is possible to combine negotiation functions in the following cases.

Negotiation between the airline and the passenger wishing to cancel/postpone their flight on the amount of cancellation fee due.

### Passengers Potentially Willing to Give Away their Ticket

1. Criteria for choosing these passengers out of the passenger list:

Flight ticket fare

How long before flight departure was the cancellation is expected

Whether the client's ticket is one way—two ways.

Discount percentage on the ticket price compared to the average gross price

Single/couple ticket in accordance with the needs of the “requesting” customer

Membership/non-membership of the airline's frequent flyer club

Personalization—age range, tickets bought by the passenger, past cancellations

Has a seat been booked/check-in processed I suitcases were sent in advance/loaded.

2. The system chooses which passengers to approach and in what order and what incentive to offer them, the aim being to minimize the cost to the airline while maximizing the chances that the passenger will agree to exchange their ticket. The system can offer the passenger a number of alternative incentives-financial, a class upgrade, points accumulation, another cheap ticket, a deal of some sort, payment plan, etc. These alternatives are calculated automatically according to the following criteria.

Personalization and/or available data on the passenger

Available seats on alternative flights

The estimated profit from the “requesting” customer

List price of the flight tickets

How long before flight departure the cancellation is expected

Whether the client's ticket is one way—two ways.

Market promotion considerations (specific package, for example)

Statistics based on past data

Number of “requesting” customers in the system at the time

Number of passengers potentially willing to give up their seat in the system at the time

Profit margin the airline is aiming for

Ticket demand on the airline's other flights

How long before the flight the ticket was booked

3. The software communicates to them via the phone, landline or mobile, e-mail or the Internet, and offers (directly or by leaving a message) to exchange their flight ticket in return for a suitable incentive. The offer is for those passengers replying up to five minutes before the deadline given to get back to the “requesting” customer. Every offer will state for how many tickets the offer is valid and that it is first comers who will get the offer. Other interested passengers may be able to get a different offer. In most cases, a passenger will only be approached once with an offer to exchange their ticket unless they themselves are interested, but the offer's deadline has past.

4. The passenger can confirm acceptance of an offer online (by phone using a touch-tone telephone or via the Internet, accessing the relevant site), or at a later stage by phoning a call center.

5. When confirmation is received from the “canceling’ passenger the software sends them an official electronic confirmation. In conjunction, the airline deals with arranging the compensation due by automatic coordination of a new flight time and/or sending a secured notification to the relevant department (sales, finance, etc.).

6. Negotiation functions can be incorporated in the following cases:

Negotiation between the airline and the “giving-up” passenger on the compensation due.

Negotiation between the airline and the “giving-up” passenger, in cases where there is more than one passenger interested in the offer.

### “Giving-Away” Passengers that Booked a Dynamic Fare on the Internet

When booking is done on the Internet, the airlines will allow customers to make up a dynamic fare according to the airline's terms, and allow the customer to choose from the following options that affect fare price and “ticket type”. These options are offered to the customer in coordination with the airline's booking system so that what options are offered are assessed by the airline each time:

Give up the ticket if requested by the airline

Willing to give up the ticket if notified up to X hours before the flight

Willing to be approached to give up ticket for the following incentives

The passenger reserves the option to cancel/postpone the flight

Number of joint fares

Negotiation functions can be combined in the construction of the fare. Passengers booking tickets on the Internet will be able to/or will have to (depending on the fare type), check on their ticket status to see if they are still on the flight. Depending on the fare type (fare cancellation, passenger with potential to give up their ticket, “canceling” passenger) the airline will approach these passengers in the stated manner.

### Offering Customers Tickets

This system can actively approach, in certain circumstances, customers and offer them a flight ticket and/or another service and to decide at what terms to sell them the ticket.

1. This system can actively approach, in certain circumstances, customers and offer them a particular flight ticket, at a price lower or higher than the list price, by phone, mobile, e-mail or the Internet.

2. These customers are identified according to the following criteria:

Personalization data (preferred destination, average ticket price, membership of customer club, etc.)

Number of points accumulated with frequent flyers club

3. The approach with an offer of a cheaper ticket will be in these cases:

There are passengers wishing to postpone/cancel their flight and there are no “requesting” customers in the system.

There are X available seats left some time prior to the flight

4. The approach with an offer of a more expensive ticket will be in these cases:

A popular event at a certain destination to which there are no tickets left for the right dates (Olympics, professional exhibition, etc.)

Periods of high demand (festivals and holidays)

5. Some of the offers will be unique to the specific customer based on personal data, and some will be on a “first come first serve” basis.

6. The price of each offer will be calculated according to the following criteria:

The gross price of the flight.

Number of customers given the offer

Personalization of the customers being offered ‘the offer’

Number of available seats on the flight/package

Marketing promotion considerations

The expected cost to the airline of the unused seat.

The profit margin the airline wishes to achieve from the system

Statistics of past prices

7. The deadline by which an answer has to be given will be determined by the system based on the following criteria:

How long before the flight the ticket was booked (urgency of the order)

Number and personalization data of the customers being offered ‘the offer’

Statistics on when tickets are confirmed

Number of available seats on the flight/package

8. The customer can receive the offer online (on the phone by using a special button and on the Internet by accessing the relevant site), or at a later stage by phoning a call center.

9. When the customer accepts the offer, the software sends an official electronic confirmation and adds their name to the passenger list. In conjunction, the airline deals with collecting payment by sending a secured notice to the frequent flyers' club department, which deducts points in return for the ticket, and/or the finance department.

### WORKING FLOW DIAGRAMS

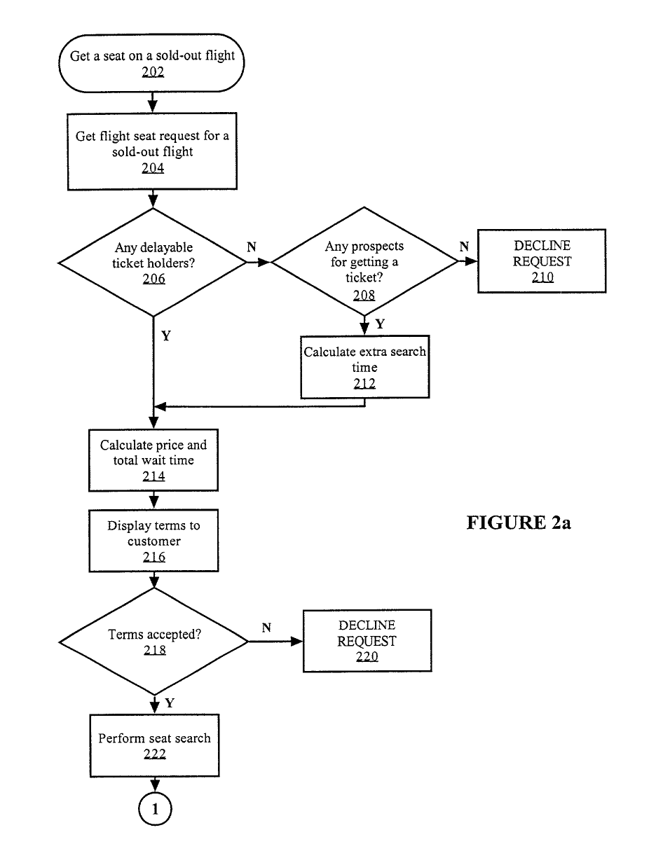

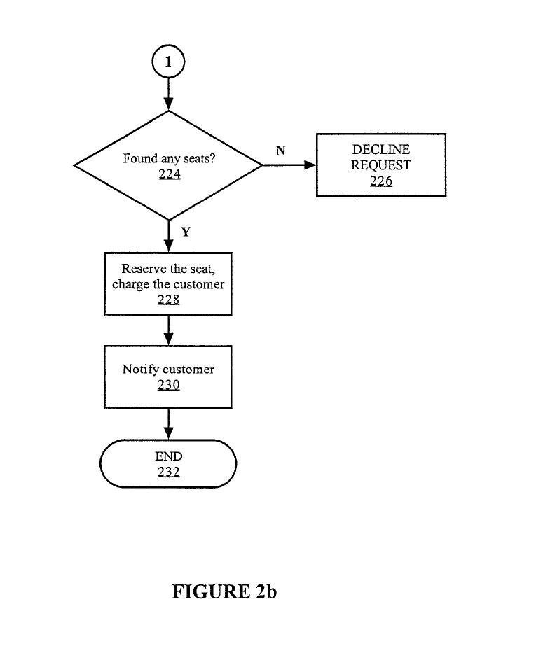

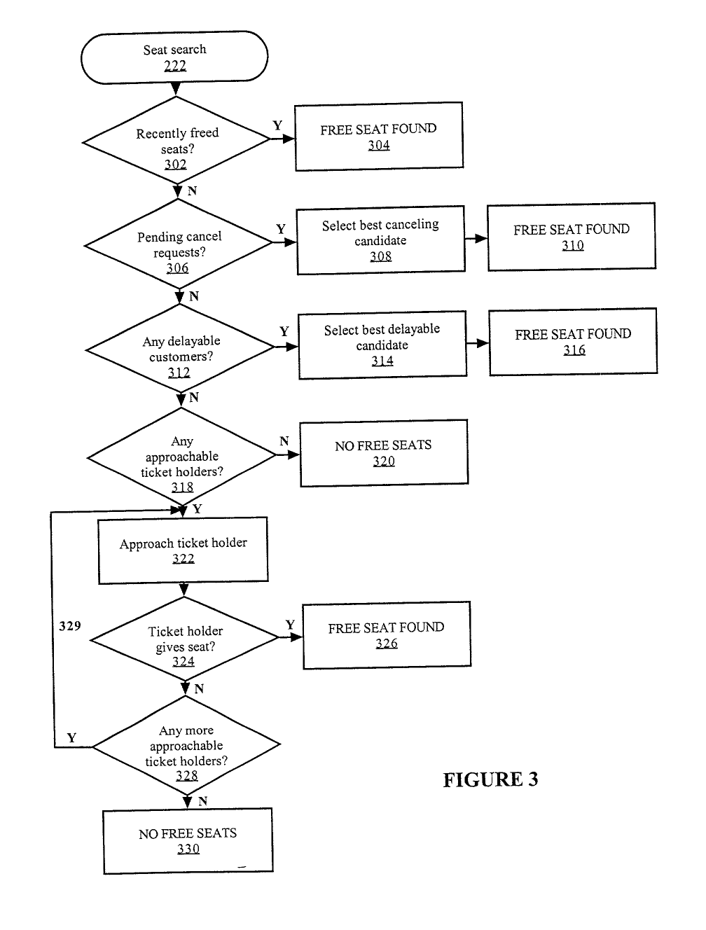

FIGS. 2a, 2b and 3 collectively illustrate a flowchart of the seat requesting processing of the present invention.

202—a requesting customer sets out to try and obtain a seat on a sold out flight. In a preferred embodiment, the customer contacts an airline website/web page through the Internet.

204—the system receives a specific request for a sold out flight.

206—the system determines if any delayable ticket holders are booked on the specified flight.

208—if no delayable ticket holders exist, the system determines if any prospects for obtaining a ticket exist.

210—if no prospects exist, the request is declined, else

212—the system calculates extra search time needed.

214—total price and wait time to confirmation are calculated.

216—The terms are displayed to the customer.

220—If terms not accepted, decline 220

218—a seat search is performed 222 (FIG. 3); If a seat is not found 224, the request is declined 226, else

228—the seat is reserved and price charged.

230—The customer is notified

232—process completed.

Referring to FIG. 3:

222—seat search start from FIG. 2a

302—determination of free seats made, if a recently freed seat was found, end search 304, else

306—any pending cancellation requests?—yes, select best candidate 308—end search 310, else

312—any delayable customers?—yes, select best candidate 314—end search 316, else

318—any approachable ticket holders?—no, no seats available, end search 320, else

322—approach ticket holder (typically through Internet)

324—does ticket holder give-up seat?—yes, free seat found, end search 326, else

328—any more approachable ticket holders? yes repeat approach loop 329, else

330—no seats available, end search 330.

The above travel related software and its described functional elements are implemented in various computing environments. For example, the present invention may be implemented on a conventional IBM PC or equivalent, multi-nodal system (e.g. LAN) or networking system (e.g. Internet, WWW, wireless web, etc.). All programming, GUIs, display panels and dialog box templates, and data related thereto are stored in computer memory, static or dynamic, and may be retrieved by the user in any of: conventional computer storage, display (i.e. CRT) and/or hardcopy (i.e. printed) formats. The programming of the present invention may be implemented by one of skill in the art of computer programming. Computing-based systems include, but are not limited to the above cited computing environments as well as communications systems (e.g., DTMF telephone based, etc.).

### Conclusion

A system and method has been shown in the above embodiments for the effective implementation of a optimized way of exchanging lower priced travel products for higher priced ones. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware and specific iconic color or symbol schemes. The software can be applied to other areas in the travel industry (e.g., hotels, trains, water transportation (cruises), rental cars, etc.) in particular and in other areas in general (e.g., event tickets (sporting, theatre, etc.)).

We claim:

1. An e-commerce system that increases revenues of a travel products supplier on a per product use basis by automatically balancing the consumption of products between travelers who have different demand curves for the same product which is sold out at a given time prior to actual use of the product, said system comprising one or more computing elements, said one or more computing elements located locally or remotely across networks, said system comprising:
traveler communications platform to enable computer based communications between the travel products suppliers and a potential or existing traveler;
one or more sources of product information, said product information including any of: product specific data, present bookings, fare rates, individual traveler data, and historical data;
rule based processing system, said rule based processing system operational to process input/output data from/to said travelers in conjunction with said product information;
computer based requests from potential travelers to book products that are said sold out product;
a source of potential traveler alterable products, said alterable products including any of: delayable fare, voluntary modified, rule based selection, and said rules based processing system intelligently exchanging lower priced products of said source with higher priced products from said computer based requests.

2. An e-commerce system that increases revenues of a travel products supplier on a per product use basis, as per claim 1, wherein said rule based processing is performed by one or more of: individual travel products supplier computing systems, a central Internet website for all travel products suppliers, and a central Internet website with web pages for each travel products supplier.

3. An e-commerce system that increases revenues of a travel products supplier on a per product use basis, as per claim 1, wherein said rule based system returns to said computer based requests conditions and terms of a possible match to their request, said possible match based on a rules based match from said source.

4. An e-commerce system that increases revenues of a travel products supplier on a per product use basis, as per claim 3, wherein said conditions and terms include at least price as calculated by said rules based systems using as an input one or more of:
customer-sensitive yield management systems data, specific price parameters set by individual travel products suppliers, list price of the product, how long before departure the order was placed (urgency of the order), number of requesting travelers, how many travelers holding alterable fare products, how many travelers with the potential to give away their seat are booked on the product, number of available products on corresponding departures, personal data available on requesting travelers, sales promotion considerations, anticipated cost to the travel products suppliers to change the product, profit margin that the travel products supplier wishes to attain using the system, and past price statistics.

5. An e-commerce system that increases revenues of a travel products supplier on a per product use basis, as per claim 1, wherein said system uses one or more of the following criteria to determine the latest time by which the system confirms booking of a requested product:
how long before departure the product was requested (urgency of the order), how many travelers with alterable based products are booked, how many travelers with the potential to give away their seat are booked, personal data available in the system on the requesting customer, and statistical data on the product confirmation times.

6. An e-commerce system that increases revenues of a travel products supplier on a per product use basis, as per claim 1, wherein if there are no available seats for the requesting traveler, the system scans an existing booked travelers list and decides the order in which travelers should be approached using rules from said rule based processing system.

7. An e-commerce system that increases revenues of a travel products supplier on a per product use basis, as per claim 1, wherein said alterable based products comprise one or more of the following restrictions or conditions: rescheduling of the traveler's departure up to a designated time frame before departure, rebooking onto another mutually acceptable departure, financial reimbursement, the number of times the travel products supplier can postpone a traveler's departure, penalties for traveler initiated cancellation, cancellation of jointly arranged products.

8. An e-commerce system that increases revenues of a travel products supplier on a per product use basis, as per claim 6, wherein said order to approach travelers with alterable products is determined by said rule based system according to one or more of the following rules: price of the product, single vs. joint, type of traveler comprising age, membership of the travel products supplier's customer club, number of reschedules the customer has had so far, how long before departure the product was booked, booking status, financial status, luggage status.

9. An e-commerce system that increases revenues of a travel products supplier on a per product use basis, as per claim 1, wherein for travelers selected for alteration, the system automatically coordinates newly available seats via electronic communication with a travel products supplier booking center.

10. An e-commerce system that increases revenues of a travel products supplier on a per product use basis, as per claim 1, wherein travelers of said products voluntary modified can retrieve from said system possible modification fees in advance thereof.

11. An e-commerce system that increases revenues of a travel products supplier on a per product use basis, as per claim 10, wherein said system can either accept/or reject the modification request within a given time period and the modification fee is defined according to one or more of the following rules: list price of the product, fare type, time left before the departure, personalization of the travelers wishing to give away their product, number of requesting travelers in the system, personalization of requesting travelers, whether or not the product is fully booked, past statistics, number of travelers with alterable products are on a specific departure, number of travelers wishing to give away their seats at the same time, and how long before departure the product was booked.

12. An e-commerce system that increases revenues of a travel products supplier on a per product use basis, as per claim 6, wherein said system selects travelers to cancel from said approached travelers from said list as per one or more of: product fare, how long before departure the cancellation takes place, whether the product is one way or two way, discount percentage on the price compared to an average list price, single/joint type in accordance with needs of the requesting traveler, membership/non-membership in an travel products supplier's frequent user club, personalization, age range, products bought by the traveler, past cancellations, seat status, and luggage status.

13. An e-commerce system that increases revenues of a travel products supplier on a per product use basis, as per claim 1, wherein said system offers cancellation incentives based on one or more of: personalization, available data on the traveler, available products on alternative departures, estimated profit from the requesting traveler, list price of the products, how long before departure was the cancellation, whether the client's product is one way or two way, market promotion considerations, statistics based on past data, number of requesting travelers in the system at the time, number of travelers potentially willing to give up their seat in the system at the time, profit margin a travel products supplier is aiming for, demand on a travel products supplier's other departures, and how long before departure the ticket was booked.

14. An e-commerce system that increases revenues of a travel products supplier on a per product use basis, as per claim 1, wherein said requesting travelers interactively review options and corresponding effect on price during an online session, said options including any of: giving away the product if approached by the travel products supplier, willingness to give away the product if notified up to X hours before departure, willing to be approached to give away product for specified incentives, getting the option to cancel/postpone, and number of joint products.

15. An e-commerce system that increases revenues of a travel products supplier on a per product use basis, as per claim 1, wherein said system requesting travelers can order a travel packaged product.

16. An e-commerce system that increases revenues of a travel products supplier on a per product use basis, as per claim 1, wherein said use of said source results in alteration of entire travel packages.

17. An e-commerce system that increases revenues of a travel products supplier on a per product use basis, as per claim 1, wherein said system actively approaches customers and offers them a product or another service and the associated terms and conditions.

18. An e-commerce system that increases revenues of a travel products supplier on a per product use basis, as per claim 17, wherein the price that was offered will be computed according to one or more of: the list price, number of customers given the offer, personalization of the customers being given the offer, number of available seats, marketing promotion considerations, expected cost of an unused seat to the travel products supplier, the profit margin the travel products supplier wishes to achieve from the system, and statistics of past prices.

19. An e-commerce system that increases revenues of a travel products supplier on a per product use basis, as per claim 17, wherein the system can offer packages instead of separate products.

20. A method of doing business incorporating a rules based system to intelligently exchange travel tickets on overbooked transportation before actual use of the tickets, said method comprising:
receiving one or more requests from potential travelers;
determining if seats are available, if so, booking said request, else generating a list of potential tickets which can be delayed;
using rules of said rules based system: determining a selection order to approach said potential delayable tickets, said rules including one or more of: recognizing delayable based tickets, noting travelers requesting cancellation, determining travelers most likely to give-up their tickets;
matching said requesting potential travelers to the best available delayable ticket;
compensating said delayed ticket traveler, and booking said matched ticket for said received request.

21. A method of doing business incorporating a rules based system to intelligently exchange travel tickets on overbooked transportation, as per claim 20, wherein said method is performed over any of: the Internet, landline telephone system, mobile telephone system.

22. A method of doing business incorporating a rules based system to intelligently exchange travel tickets on overbooked transportation, as per claim 20, wherein said rule based system processes said method by one or more of: individual travel products suppliers computing systems, a central Internet website for all travel products supplier, and a central Internet site with web pages for each travel products supplier.

23. A method of doing business incorporating a rules based system to intelligently exchange travel tickets on overbooked transportation, as per claim 20, wherein said rule based generates conditions and terms for said match.

24. A method of doing business incorporating a rules based system to intelligently exchange travel tickets on overbooked transportation, as per claim 23, wherein said conditions and terms include at least ticket price as calculated by said rules based system using as an input one or more of: customer-sensitive yield management systems data, specific price parameters set by individual travel products suppliers, list price, how long before departure the order was placed (urgency of the order), number of requesting travelers, how many travelers holding cancellation fare tickets, how many travelers with the potential to give away their seat are booked, number of available tickets on corresponding departures, personal data available on requesting travelers, sales promotion considerations, anticipated cost to the travel products supplier to change the ticket, profit margin that the travel products supplier wishes to attain using the system, and past price statistics.

25. A method of doing business incorporating a rules based system to intelligently exchange travel tickets on overbooked transportation, as per claim 20, wherein said system uses one or more of the following criteria to determine the latest time by which the rules based system confirms booking of a requested ticket:
how long before departure the ticket was requested (urgency of the order), how many travelers with cancellation based tickets are booked, how many travelers with the potential to give away their seat are booked, personal data available in the system on the requesting customer, and statistical data on the ticket confirmation times.

26. A method of doing business incorporating a rules based system to intelligently exchange travel tickets on overbooked transportation, as per claim 20, wherein said cancellation based tickets comprise one or more of the following restrictions or conditions: rescheduling of the traveler's departure up to a designated time frame before departure, rebooking onto another mutually acceptable departure, financial reimbursement, the number of times the travel products supplier can postpone a traveler's departure, penalties for traveler initiated cancellation, cancellation of jointly arranged tickets.

27. A method of doing business incorporating a rules based system to intelligently exchange travel tickets on overbooked transportation, as per claim 20, wherein said order to approach travelers with cancelable tickets further comprises any of the following parameters: price of the ticket, single vs. a joint ticket, type of traveler comprising age, membership of the travel products supplier's customer club, number of reschedules the customer has had so far with their ticket, how long before departure the ticket was booked, booking status, financial status, luggage status.

28. A method of doing business incorporating a rules based system to intelligently exchange travel tickets on overbooked transportation, as per claim 20, wherein for travelers selected for cancellation, the method automatically coordinates newly available seats via electronic communication with a booking center.

29. A method of doing business incorporating a rules based system to intelligently exchange travel tickets on overbooked transportation, as per claim 20, wherein said voluntary cancellation travelers are presented with possible cancellation fees in advance thereof.

30. A method of doing business incorporating a rules based system to intelligently exchange travel tickets on overbooked transportation, as per claim 20, wherein said system can either accept/or reject the cancellation request within a given time period and a cancellation fee is defined according to one or more of the following rules: list price, fare type, time left before the departure, personalization of the travelers wishing to give away their ticket, number of requesting travelers in the system, personalization of requesting travelers, whether or not the departure is fully booked, past statistics, number of travelers with cancelable ticket are on a specific departure, number of travelers wishing to give away their seats at the same time, and how long before departure the ticket was booked.

31. A method of doing business incorporating a rules based system to intelligently exchange travel tickets on overbooked transportation, as per claim 20, wherein said method selects travelers to actually cancel from said approached travelers from said list as per one or more of: ticket fare, how long before departure the cancellation takes place, whether the ticket is a one way or a two way ticket, discount percentage on the ticket price compared to an average list price, single/joint ticket in accordance with needs of the requesting traveler, membership/non-membership in a travel product supplier's frequent flyer club, personalization, age range, tickets bought by the traveler, past cancellations, seat status, and luggage status.

32. A method of doing business incorporating a rules based system to intelligently exchange travel tickets on overbooked transportation, as per claim 20, wherein said cancellation incentives are based on one or more of: personalization, available data on the traveler, available seats on alternative departures, estimated profit from the requesting traveler, list price of the tickets, how long before departure was the cancellation, whether the client's ticket is one way or two way, market promotion considerations, statistics based on past data, number of requesting travelers in the system at the time, number of travelers potentially willing to give up their seat in the system at the time, profit margin a travel product supplier is aiming for, ticket demand on a travel product supplier's other departures, and how long before departure the ticket was booked.

33. A method of doing business incorporating a rules based system to intelligently exchange travel tickets on overbooked transportation, as per claim 20, wherein said method includes an Internet based method enabling interactive review of options and corresponding effect on price during an online session, said options including any of: giving away the ticket if approached by a travel product supplier, willingness to give away the ticket if notified up to X hours before departure, willing to be approached to give away ticket for specified incentives, getting the option to cancel/postpone the trip, and number of joint tickets.
